(19) United States
(12) Patent Application Publication
(10) Pub. No.: US 2008/0042817 A1
(43) Pub. Date: Feb. 21, 2008

(54) TEMPERATURE COMPENSATED TIRE PRESSURE MONITORING SYSTEM WITHOUT DIRECT TIRE TEMPERATURE MEASUREMENT

(75) Inventor: Kenneth A. Fogelstrom, Fort Wayne, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(73) Assignee: INTERNATIONAL TRUCK INTELLECTUAL PROPERTY COMPANY, LLC, Warrenville, IL (US)

(21) Appl. No.: 11/464,875

(22) Filed: Aug. 16, 2006

(51) Int. Cl. B60C 23/02

(52) U.S. Cl. 340/442

(57) ABSTRACT

A tire pressure management system for a tractor/trailer system establishes allowable bounds for tire pressure compensated for temperature and determines leaks after determining that internal tire temperature measurements are not available. The system is based on valve-mounted external tire pressure sensors, wireless connections to uplink tire pressure data, keyed by location, an ambient temperature sensor and an onboard computer. Tires are assumed pressurized to a target pressure at a given temperature with minimum and maximum pressure bounds set around the target pressure. Ambient temperature sensing, and determination that tires are likely to be at ambient temperature, allows adjustment of the minimum and maximum bounds, as well as the target pressure, compensated for temperature and thus a judgement made as to whether the cold pressure reading indicates deviation from acceptable limits. Determination of whether the vehicle is, or has recently been in movement, is made allowing internal temperature of the tires to be estimated based on changes in pressure. Inter-comparison of pressure readings from among the tires is used to determine the occurrence of leaks during vehicle operation.

### BACKGROUND OF THE INVENTION

1. Technical Field

The invention relates to tire pressure monitoring systems.

2. Description of the Problem:

Tire pressure monitoring systems (TPMS) provide for alerting drivers to variation in measured tire pressure from desired norms particularly while the vehicle is in operation. As is well known from Boyle's law, the pressure of a fixed quantity and volume of air is proportional to its temperature. Absent compensation for the effects of temperature changes, TPMS report actual tire pressure. For example, a truck tire inflated to 100 psi when cold could easily be reported as pressurized to 115-125 psi when the vehicle is running at highway speeds. Conversely, if ambient temperature were to drop after filling a tire, a low pressure warning might be generated. Without temperature compensation it is difficult for TPMS to determine if a pressure change is due to a leak or to temperature changes.

Accordingly, TPMS commonly utilize pressure and temperature sensors mounted on the wheel rim and within the tire. This allows reported tire pressure values to be adjusted for temperature changes that occur in the course of normal driving and for taking into account changes in ambient temperature occurring when the vehicle is parked. Not only does this help keep TPMS from issuing false warnings, but it allows tires to be filled when hot since the user can be directed to add air to a pressure which will match the recommended pressure after cooling. However, not all vehicles are equipped with the temperature sensors and even if they are, there still exists the difficulty of supplying such sensors with power.

Some TPMS have used externally mounted pressure sensors which attach to the valve stem in place of a valve cap. Externally mounted systems are easily retrofitted to existing commercial vehicles. This allows easy replacement upon depletion of the batteries used to energize the transmitter portion of the sensor. However, external sensors cannot conveniently provide a measurement of internal tire temperature. Vehicle operators therefore must understand the effects changes in temperature can have on tire pressure and make decisions in light of that understanding. This is not to say that no action should be taken on account of pressure changes due to ambient temperature changes, especially where consistent with movement of the vehicle from a warmer to a colder climate or to seasonal changes.

TPMS intended for use on commercial vehicles are developed with awareness of the National Highway Traffic Safety Administration Vehicle in Use Inspection Standard 570.57. TPMS allow automation of some of the inspections required of drivers of commercial vehicles.

### SUMMARY OF THE INVENTION

According to the invention a tire pressure management system for a tractor/trailer system operates to provide some features of temperature compensation when direct measurement of internal tire temperature is not available. The system first determines availability of tire temperature sources, and initializes itself for indirect compensation when such measurements are determined to be unavailable. The system is based on valve-mounted external tire pressure sensors, wireless connections to uplink tire pressure data, keyed by location, an ambient temperature sensor and an onboard computer. A target pressure at a given temperature with minimum and maximum pressure bounds set around the target pressure are set for the tires. Ambient temperature sensing, and determination that the tires are likely to be at ambient temperature, allow adjustment of the minimum and maximum bounds, as well as the target pressure, compensated for temperature and thus a judgement made as to whether the cold pressure reading indicates deviation from acceptable limits. Determination of whether the vehicle is, or has recently been, in movement allows internal temperature of the tires to be estimated based on changes in pressure. Inter-comparison of pressure readings from among the tires is used to determine the occurrence of leaks during vehicle operation.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a schematic illustration of the major components of the present tire pressure monitoring system.

FIG. 2 is a block diagram of a tire pressure monitoring system receiver.

FIG. 3 includes block diagrams for a valve-mounted sensor and a system repeater.

FIG. 4 is a flow chart of a detection routine which determines if direct measurement of tire internal temperature is available.

FIG. 5 is a flow chart of an initialization routine executed upon determination that direct internal tire temperature measurements are not available.

FIG. 6 is a flow chart for determining tire pressure when the tires are cold.

FIG. 7 is a flow chart for a routine determining if a leak has developed during running.

FIG. 8 is a flow chart for a routine continuing with checking for leaks on a running vehicle.

### DETAILED DESCRIPTION OF THE INVENTION

Referring now to the figures, a tractor/trailer combination 10 is illustrated on which a tire pressure monitoring system 30 has been installed. Tractor/trailer combination 10 comprises a tractor 12 and a trailer 14. Tractor 12 is equipped with tires 18 installed on wheels 15. Trailer 14 is equipped with tires 20 installed on wheels 17. The internal pressure of tires 18, 20 is monitored by externally mounted sensor/transmitters 38. A low pressure warning light 16 may be installed on the forward exterior wall of trailer 14 from where it can be seen from the cab of tractor 12. Antennae 22, 26 are strategically located on trailer 14 and tractor 12 for enabling radio frequency data links between the tractor and trailer to extend the tractor control system to the trailer.

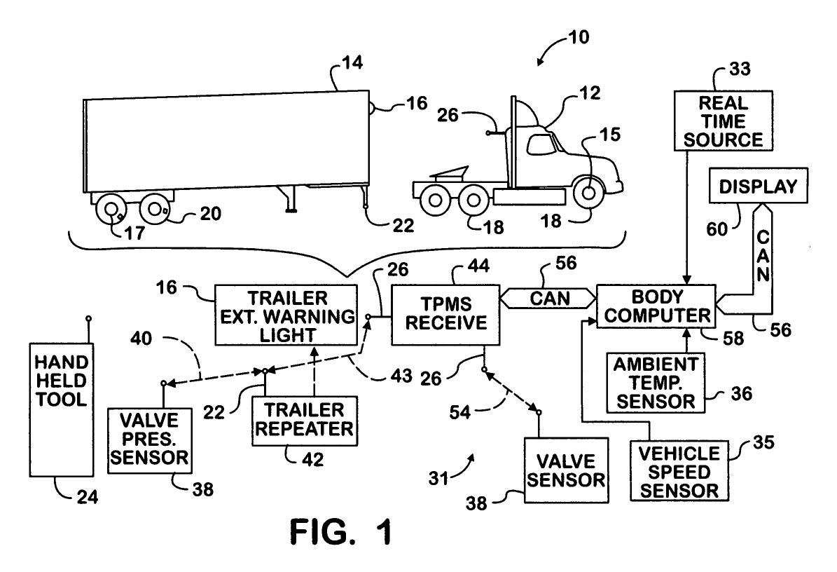

A tire pressure monitoring system (TPMS) 30 includes components installed on both the trailer 14 as well as on the tractor 12 and is topologically illustrated in FIG. 1. The TPMS 30 illustrated is a preferred embodiment suited for an OEM installation where tractor 12 is equipped with an SAE J1939 compliant controller area network (CAN) 56. Simplified systems for aftermarket installation on vehicles not equipped with a CAN are certainly possible as will be clear to those skilled in the art. Trailer 14 components are a subset 29 of the TPMS 30 and are capable of limited, stand-alone operation. A trailer 14 may be attached to a tractor 12 which does not have components required to complete TPMS system. Thus, a trailer warning light 16 is installed on the exterior of the forward wall of trailer 14 to afford subset 29 limited stand alone functionality. Trailer warning light 16 should be installed so as to be readily visible in a rear view mirror from the cab of tractor 12 and the trailer based subset 29 of TPMS 30 should be configured so as to support activation of the warning light 16 even in the absence of additional functionality of tractor-based portion 31 when low pressure is detected in any of tires 20. Trailer base portion 29 is also configured to switch automatically from battery to vehicle power if tractor power is available. As illustrated, trailer warning light 16 is used only to indicate that a tire is low on pressure, but does not indicate which tire.

Tire pressure information is made available in the cab of tractor 12 on a display 60. A receiver having the service functionality of TPMS receiver 44, less (or not using) its CAN interface, could serve as such a receiver. Where a vehicle is equipped with a controller area network 56 TPMS receiver 44 is connected to CAN 56 for transfer of data to drive display 60. A body computer 58 is programmed to compensate pressure readings for temperature-based changes in pressure notwithstanding the lack of direct temperature measurements from inside the tires if required. Data from an ambient temperature sensor 36 and a vehicle speed sensor 35 are connected to the body computer 58 to implement tire pressure management using alternatives to direct tire temperature data in implementing temperature compensation of pressure readings.

A representative TPMS 30 includes a valve pressure sensor 38 for all of tires 18, 20 on both tractor 12 and trailer 14. The valve pressure sensors 38 are typically installed on the valve stem for each wheel. The considerations involved in such installations are the usual ones of weight, balance, stem vibration, visual appeal, environmental resistance, ease of installation, clearance from the wheel and theft deterrence. Integral batteries are used to supply power to valve pressure sensors 38. The batteries are generally not replaceable and efforts are taken to maximize battery life to avoid the need for frequent replacement of the valve pressure sensors 38. This may be achieved in part using a sleep mode when the vehicle is off. Transmission frequency may be varied depending upon circumstances, for example, it may be reduced when pressure levels are acceptable. Transmission frequency can be increased in response to a variance of pressure from desired norms and upon request of the host system. Typically the transmission rate is elevated when the vehicle is moving.

A full TPMS 30 may require two or more antennae per vehicle. Provided are a tractor antenna 26 and a trailer antenna 22 for establishing a data link 43 between the vehicle sections. Trailer antenna 22 serves for repeater station 42. Tractor 12 is preferably equipped with a controller area network (CAN) 56 conforming to the SAE J1939 standard for transferring data to computers implementing higher level functions of the TPMS 30. CAN 56 will include a body computer 58 which executes management programs, including the routines described below, and which passes data to a cab display 60 where warnings and indications of tire condition are imaged.

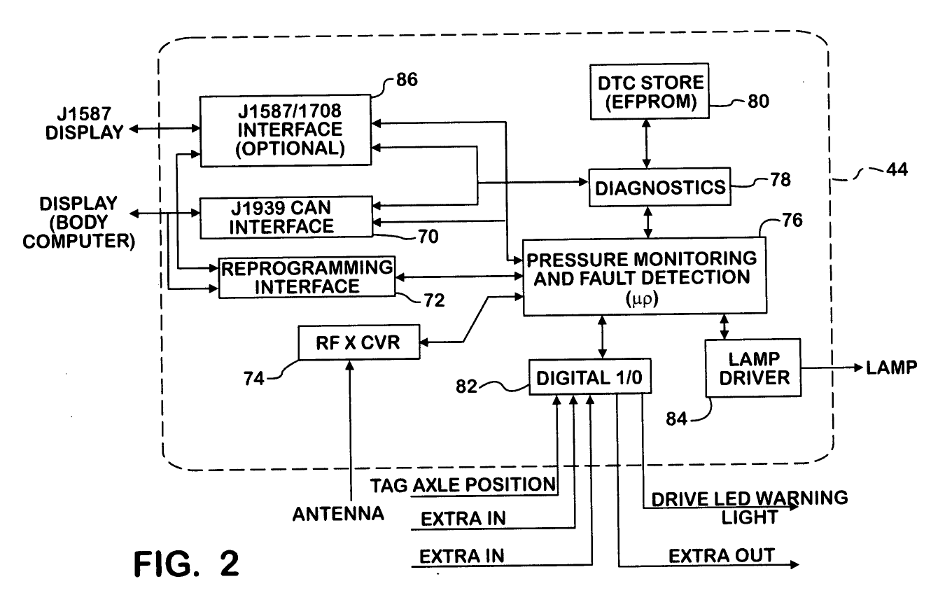

Referring to FIG. 2 a block diagram schematic of a TPMS receiver 44 is illustrated. TPMS receiver 44 includes pressure monitoring and fault detection functionality through a programmed microprocessor 76 for use in case of installation on a vehicle not having a CAN. TPMS receiver 44 typically receives wireless reports of data from valve pressure sensors 38, 46 over an antenna connected to a radio frequency transceiver 74, and reports the data to microprocessor 76. Microprocessor 76 can receive data over other channels as well including CAN 56 through J1939 interface 70 and, optionally, J1587/J1708 interface 86. A reprogramming interface may be connected to CAN 56. All interfaces are connected to supply data directly to microprocessor 76. The network interfaces 70, 86 are further connected to exchange data with diagnostics block 78. Memory 80 is available to microprocessor 76 and diagnostics block 78. Microprocessor 76 also receives inputs over a digital input/output port 82. Inputs potentially relate to axle positions specifically identified with tires. Outputs including a drive LED warning light output can be generated over digital I/O 82.

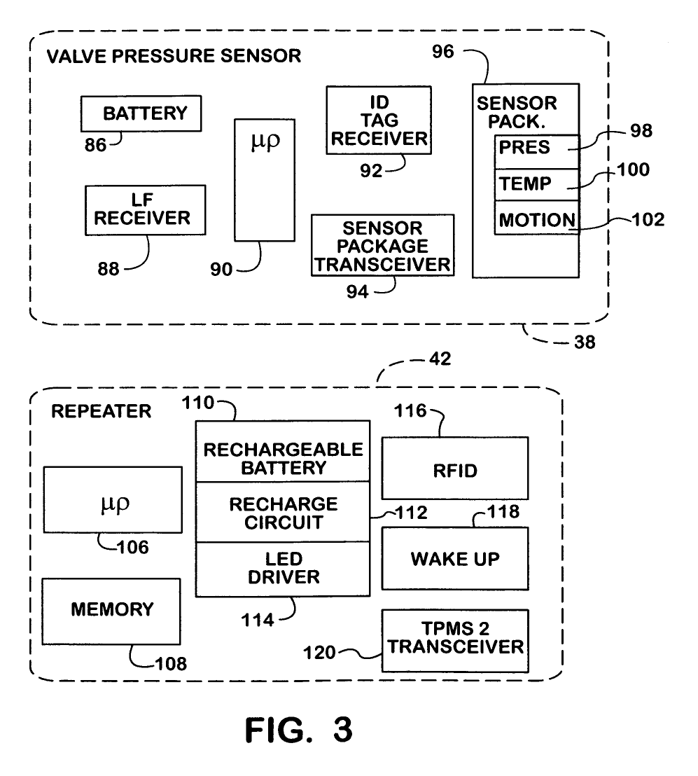

Referring to FIG. 3, functional block diagrams for valve pressure sensors 38 and trailer repeater 42 are provided. Valve pressure sensor 38 includes a battery 86, a low frequency transceiver 88 for communication with TPMS receiver 44 or trailer repeater 42, a microprocessor 90, an RFID tag reader 92 (though RFID tags are assumed not present here), a sensor package transceiver 94 and a sensor package 96 including a stem pressure sensor 98, a temperature sensor 100 providing ambient temperature at start up and a motion sensor 102. Start up ambient temperature readings may be used for temperature compensation instead of a tractor mounted, ambient temperature sensor. Trailer repeater 42 includes a local processor 106 and memory 108 and, in case no tractor TPMS is available, can function as a stand alone system performing low pressure detection. Trailer repeater 42 further includes a rechargeable battery 110, recharge circuit 112 and an LED driver 114. In order to save power repeater 42 has a power down or sleep mode and a wake up circuit 118 is provided. An RFID interrogator 116 is provided as well as a TPMS transceiver 120 for the exchange of data with transceiver 44.

Valve sensors 38 transmit data to a TPMS receiver 44 directly or by trailer repeater 42. Microcontroller 90 is programmed with a pressure threshold. In response to detection of pressure falling below the threshold, the pressure reading transmission rate increases. Normally the pressure transmission rate is quite slow to prolong battery life. A motion sensor 102 enables sensor transmission rate increases if the vehicle is moving. This allows TPMS 30 to determine fast leakage rates and other warning conditions. The programmable threshold can be reprogrammed by TPMS 30 if the system determines that operational parameters for the truck have changed. The parameters can include average climate, average load and other factors. Default parameters are selected to be universally applicable, but are preferably optimized for specific vehicles in order to improve fuel economy and prolong battery life. LF receiver 88 allows sensor 38 to be awakened and communicated with by a hand tool 24 or by repeater 42.

Repeater 42 is used as a bridge from tire pressure sensors 38 to TPMS receiver 44 which is mounted on tractor 12. RF retransmission is provided. In order to extend battery service life, repeater 42 is not always in a listening mode. An embedded RFID transceiver 116 detects when a tractor 12 has backed to the trailer 14 and a handshake signal is transmitted to TPMS receiver 44. The handshake provides the unique tire ID numbers for tires installed on the trailer 14, along with axle locations and may be used to activate repeater 42.

Wheel valve sensors 38 transmit at a slow rate when the vehicle is not moving. Repeater 42 includes a rechargeable battery 86, which provides power allowing the repeater to receive these signals and to store the most recent data. If a leak is detected, an LED, which is mounted on trailer 14 where easily seen, is set to flashing. This serves to alert yard mechanics to attend to the tires when a tractor is not present. If a tire pressure problem exists when the tractor comes into position to connect to the trailer 14, repeater 42 alerts the TPMS 30 upon activation. When a tractor 12 connects to a trailer 14 the repeater's battery 86 goes into recharge mode and the repeater begins to use the tractor's power supply.

Tractor 12 is also equipped with an RFID interrogator 25, which maybe UHF or LF-BASED depending upon the required transmission range. RFID interrogator 25 is located in an area where it will activate a trailer mounted RFID tag 116 when the tractor comes within five feet of the trailer which can in turn supply a wake up signal to repeater 42. Interrogator 25 may be triggered by the driver, automatically or when a particular state is true, for example, if the tractor is in reverse. Tractor RFID interrogator 25 listens for a response identifying the trailer 14 and for trailer conditions requiring attention. Again the present invention assumes that the response to interrogator 25 inquiries directed to determine if RFID tags 116 are present is negative. Such RFID tags would provide tire temperature measurements and their absence could be one, among several, causes for the absence of tire temperature readings.

The present invention provides some of the attributes of temperature compensation for detected pressure measurements absent availability of temperature readings from the tires. Readings from an ambient temperature sensor, such as may be located in a vehicle's air intake or on the valve stems are available to on board vehicle computer, as are tire pressure readings. As is well know, tire pressure and temperature are positively correlated. If a pressure drop occurs due to a leak then temperature will also decrease, provided all other factors remaining unchanged. However, if a vehicle is in motion a pressure drop will result in more sidewall flexing of the tire, resulting in the generation of heat and a rise in the temperature inside the tire (with a consequent increase in pressure and, often, the leak rate). Leaks may be difficult to detect quickly when the only variable monitored is pressure. Programming for the vehicle computer is adapted to determine initially whether tire temperature readings are available.

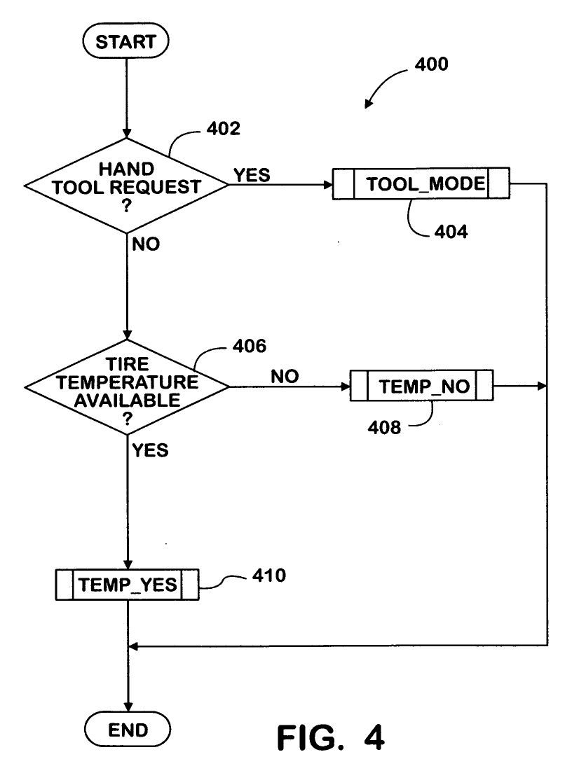

Referring to FIG. 4, a routine 400 executed on vehicle start sets flags indicating whether tire temperature is available. Step 402 indicates whether use of a hand tool has been requested. If so a tool mode flag is set at step 404 following the YES branch from step 402 and the program ends. The pertinent path here is the NO path from step 402 and a determination if tire temperature is available at step 406. If not, following the NO branch advances processing to step 408 where the Temp_No flag is set. Otherwise processing advances along the YES branch to step 410 where the Temp_Yes flag is set. After flags are set in any of steps 404, 408, or 410 the process ends. As should be clear from the character of tests employed, the subsequent series of routines are executed repeatedly after the vehicle has been turned on. The balance of the discussion assumes that the Temp_No flag was set in routine 400.

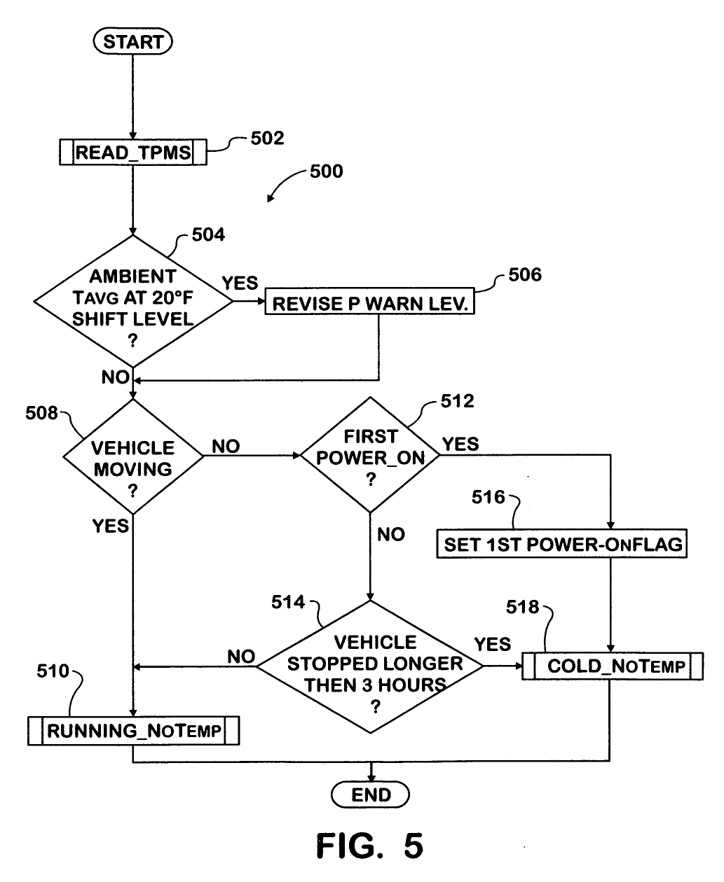

Referring to FIG. 5, an initialization routine 500 executed upon determination that tire temperature signals are not available is illustrated. Step 502 indicates the report of pressure signals from the valve pressure sensors 38. The next decision step 504 reflects that when tires are filled to a recommended pressure, a temperature at which that pressure occurs is implicit. If done casually, the temperature will be the prevailing temperature at the time the tire is filled. Commercial operators are however more likely to be explicit about a temperature choice, depending upon time of year and the prevailing geographic location of operation of a vehicle. Consider an operator of vehicles which are usually located in Texas confronted with transfer of a vehicle for sustained operations in Manitoba in January. Absent adjustment of the quantity of air in the tires of a vehicle the measured pressure in the tires can be expected to drop substantially, even though no leak has occurred. While an operator may not change inflation of the tires it may be necessary to adjust warning levels to avoid generating false leak indications. Accordingly a shift in ambient temperature shift levels may be indicated at step 504. This may occur automatically, if the vehicle records temperature readings and notes a sustained change over a period of days, as would occur upon relocations of a vehicle from a warm to a cold climate. Or, an operator, anticipating a shift in operations, may program a change in the shift level. It is even possible that a vehicle equipped with a global positioning sensor could use its position and date information to access meteorological data bases or weather forecasts and generate an anticipated or expected ambient temperature for the purposes of setting shift levels. In any event, an indication that the shift level requires change results in revision of pressure warning levels at step 506 following the YES branch from step 504. Absent a change in expected ambient temperature the NO branch is taken.

The balance of routine 500 is directed to determining if the tires may be considered to be cold, that is, at ambient temperature and setting appropriate flags indicative of this state or for use in determining if this state holds. Following step 506 or the NO branch from step 504 processing leads to a decision step 508 to determine if the vehicle is moving from the vehicle speed sensor 35. If the vehicle is moving the YES branch is followed to step 510 which sets, or confirms, that the Running_NoTemp flag is set, which in effect indicates that the tires are not at ambient temperature, and the process ends. If the vehicle speed sensor 35 indicates that the vehicle is stopped additional tests are required before it can be assumed that the tires are at or have returned to ambient temperature. First an inquiry (step 512) is made to see if the vehicle has been started for the first time that day. If not, step 514 is executed to determine if the vehicle has been halted for a minimum of three hours, the time period required to allow cooling of the tires to ambient. If the vehicle has been stopped for three hours step 518 is executed to set the “Cold_NoTemp” flag indicating that the tires may be assumed to be at ambient temperature and processing ends. If the vehicle has not been stopped for a minimum of three hours as determined at step 514, the NO branch is taken to step 510 and the “Running_NoTemp” flag is confirmed.

Returning to step 512, if it is determined that the vehicle start if the first of the day, then the YES branch is followed to step 516 where a “First Power_On” flag is set followed by execution of step 518 where the “Cold_NoTemp” flag is set.

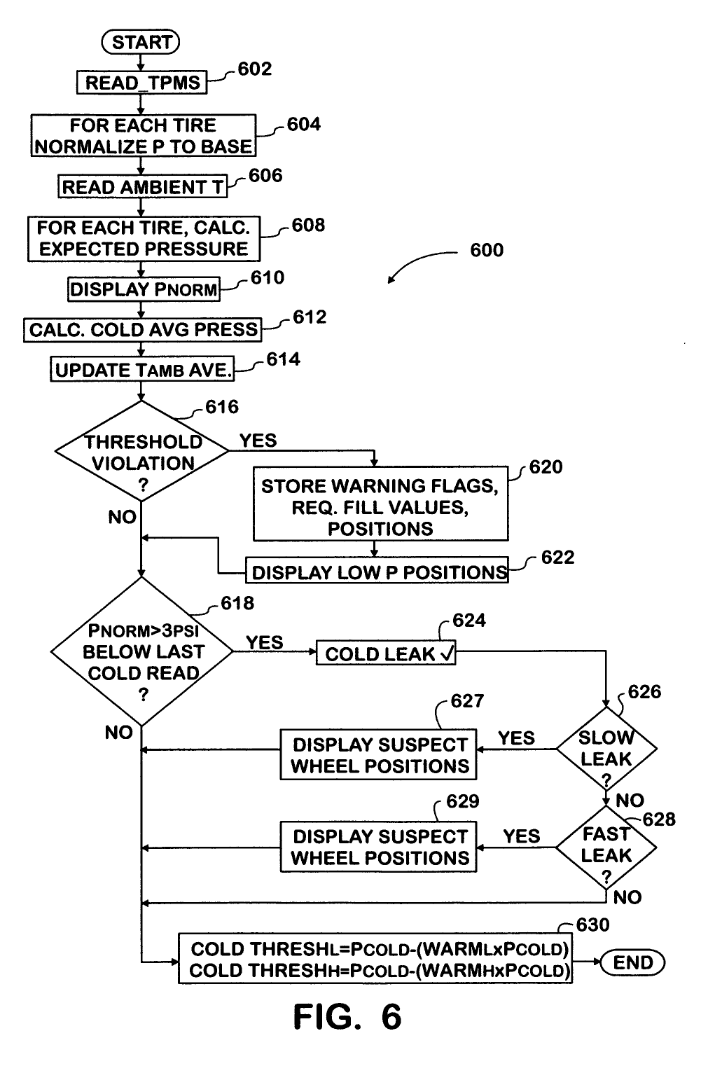

Referring to FIG. 6 a routine 600 provides for estimating temperature compensated tire pressure is illustrated. It is assumed that a fleet operator has supplied a target fleet air pressure at a predetermined temperature T, here assumed to be about 70° F. (294 Kelvins). At step 602 tire pressure readings are taken from the tire pressure management system. Next, for each tire, the pressure reading P is normalized to the first measured temperature T_{BASE} for the day. Normalization requires a pressure adjustment:

ΔP=(T_{BASE}−T)×(P_{SLOPE})

then,

P_{NORM}=P+ΔP

where,
P_{NORM}=105 psi (or as set by operator)
P_{SLOPE}=0.35 (ΔP/ΔT over T)
P, P_{NORM} are measured pressure.

Next, at step 606 the variable T_{AMBIENT} is initialized to the first measured temperature T_{BASE}. Next, at step 608 an expected cold pressure for each tire is calculated;

P_{COLD}=P_{BASE}+ΔP

Next, at step 610, the expected pressure P_{NORM} for each tire is displayed. Next, at step 612, the cold average pressure (P_{avgCold}) for each group of tires is determined. Typically one group of tires is taken to be the tires 18 installed on the tractor 12 and the second group of tires is taken to be the tires 20 installed on the trailer 14. Next, at step 614, a new ambient temperature average is calculated, if actual readings are used for updating whether a change in shift level is required.

The routine must, of course, provide basic warnings of pressurization problems with the tires. At step 616 it is determined if one or more compensated pressures violate one of the pressure thresholds WarnLow or WarnHigh:

P<(WarnLow×P_{COLD}), or

P>(WarnHigh×P_{COLD}).

If one of the pressure thresholds was found violated at step 616 processing advances along the YES branch to step 620 where the appropriate warning flags are stored, the required fill pressure determined (FillPress=P_{COLD}−P_{NORM}), and the positions of the tires determined to be over or under filled stored. Step 622 indicates display of the low pressure tire positions before processing returns to step 618. Where no violation has occurred then the NO branch from decision step 616 advances processing directly to decision step 618. At step 618 it is determined whether P_{NORM} is more than 3 psi lower than that determined at the time of the last cold read. If so, a possible leak is present and a cold leak check 624 is done to determine whether a slow or fast leak is present. Successive tests 626 and 628 are used for locating slow and fast leaks, respectively, which are equated to the speed of pressure loss. Positive results of the tests lead to suspect wheel positions being displayed and storage of warning flags for the tires suspected of leaking (steps 627, 629). If the pressure loss is determined not to be leak related, and after storage of results when a leak is found, processing returns to the main path following the No result from step 618 to a step 630 where the values ColdThreshLow and ColdThreshHigh are set before the process is terminated:

ColdThreshLow=P_{COLD}−(WarmLow×P_{COLD})

ColdThreshHigh=P_{COLD}+(WarmHigh×P_{COLD}).

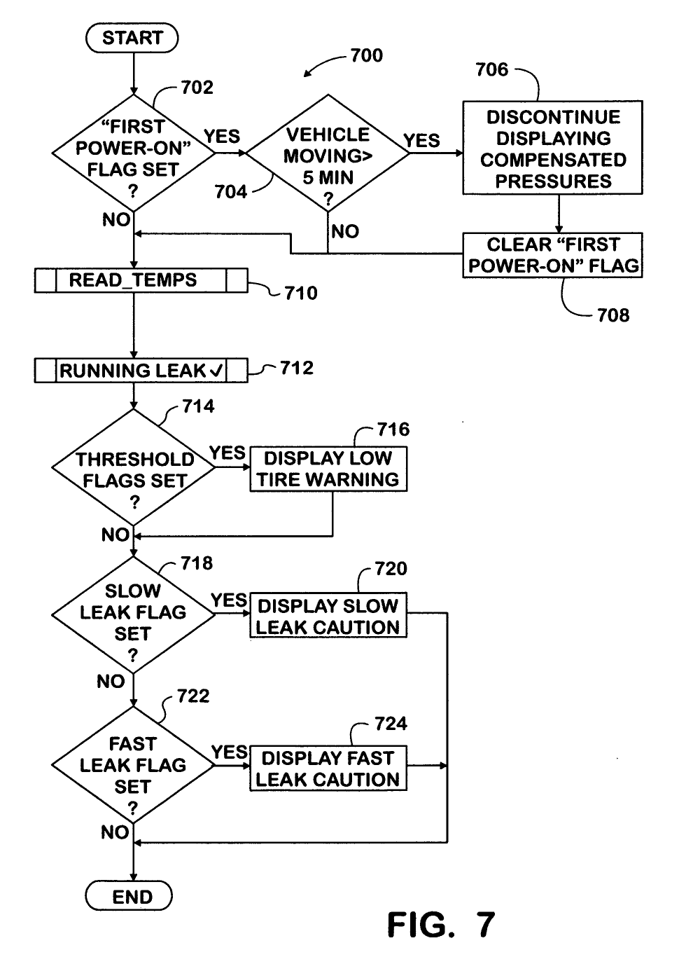

For a running vehicle it is not strictly necessary to know the pressure for a tire, but rather the problem sometimes is determining whether a leak is occurring or if a tire has become under inflated. The routine 700 described with reference to FIG. 7 provides: determination of whether a warning threshold has been crossed during operation; leakage detection by comparing tire pressure among the tires of the vehicle; and display of warnings, but does not provide actual pressure readings after the first five minutes of vehicle movement. When measured pressure for a tire falls below a low pressure warming threshold, we can compare that tire's pressure against pressure measurements for the vehicle's other tires, or those for the axle on which the first tire is installed. An algorithm may be designed a number of ways to determine if the pressure drop stems from temperature change, rather than a leak, since we would expect all the tires on an axle to behave essentially the same, unless a leak has occurred. At step 702 it is determined if the “First Power_On” flag is set. If it is, step 704 is executed to determine if vehicle has been in motion for at least five minutes, and, if so, steps 706 and 708 are executed to discontinue display of tire pressures and to clear the “First Power_On” flag. Following the NO branches from steps 702 or 704, or following execution of step 708, step 710 is executed by interrogating the tire pressure management system for current pressure readings. Then, at step 714, a running leak check is executed. This involves a comparison of each individual pressure reading against the average for all the tires on the vehicle, a variable termed P_{AVGHOT}. Alternatively, a comparison may be made among the tires of a given axle.

Next, step 714 is executed to determine if the threshold flags were set from step 620 indicating threshold violations during cold pressure measurements. If so, following the YES branch from decision step 714 to step 716, a low tire warning indicating the position of the tire or tires in violation executed. After step 716 or following the NO branch from step 714 decision step 718 is executed to determine if a slow leak flag was previously set at step 627. If YES, a slow leak caution warning is provided at step 720. If no slow leak flag was set, step 722 is executed to determine if the fast leak flag has been set. If so a fast leak warning is displayed per step 724.

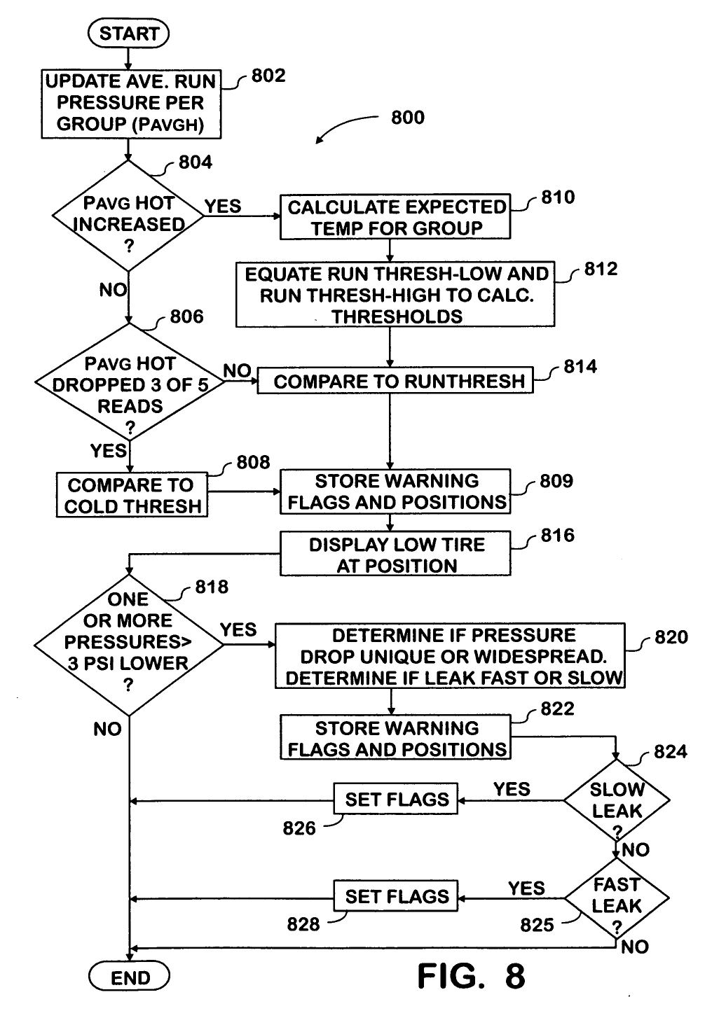

Actual compensated pressure is known when tires are at ambient (i.e. “cold”). These values serve as a baseline pressure when the tires heat up during use. The complication is to determine if a tire is leaking even whilst its pressure increases due to temperature increases. The routine 800 of FIG. 8 tracks group average pressure from which an average expected temperature is calculated. From this a threshold is found, normalized to cold pressure and base temperature. Then it is determined if a particular tire has crossed below the newly established lower limit threshold indicating a leak. Any indicated leak is characterized as being fast or slow.

Beginning at step 802, the average running pressures P_{AVGH} are updated for each of the two groups of tires. At step 804 it is determined if these values have increased since the last determination. If yes, then execution is advanced to steps 810 and 812 where Boyle's Law is used to determine an expected temperature (normalized to P_{BASE} and T_{BASE}) assuming that the quantity of air and volume of the tires has remained unchanged.

T_{EXP}=T_{AMB}×P_{AVGH}/P_{AVGCOLD.M}

From this determination the values RunThreshHigh and RunThreshLow may be equated at step 812 to calculate thresholds for the expected (i.e. estimated) temperature of the tires.

RunThreshLow=(WarnLow×P_{COLD}×T_{EXP})/T_{BASE}

RunThreshHigh=(WarnHigh×P_{COLD}×T_{EXP})/T_{BASE}

Then all tire pressures are compared (step 809) to the new RunThresh values and the positions of tires noted to be at low pressures are displayed, stored and flagged (step 816).

Two other routes lead to step 809, each initially following a determination at step 804 that average tire pressure has not increased. At step 806 it is determined if the average tire pressure has decreased in three of the last pressure reading evaluations. If not, then the comparison of the step 814 is executed as before. If yes, then all tires' pressures are compared to cold threshold values and processing skips step 814 directly to step 809 and 816, as already described.

From step 816 processing is advanced to step 818 where it is determined if the pressure readings from one or more tires are more than 3 psi lower than that from its last reading. If not, process execution is completed and the program temporarily exited. If yes, than all of the tires pressures are compared to normative values to see if the drop is unique, confined to a few tires, or if it is widespread. If the drops are not widespread then leaks are indicated and the leaking tires are flagged by position (step 822) and the leaks are characterized as slow or fast (steps 824, 825) depending upon how quickly pressure is changing in the tires. Once the characterizations have been made, the appropriate flags are set at steps 826, 828.

Accordingly, the invention provides a back up for temperature compensation when direct indication of tire temperature is unavailable.

While the invention is shown in only one of its forms, it is not thus limited but is susceptible to various changes and modifications without departing from the spirit and scope of the invention.

What is claimed is:

1. A pressure monitoring system for a plurality of tires installed on wheels of a motor vehicle, the motor vehicle being potentially assembled from component sections including tractor and trailers, the pressure management system comprising:
a plurality of tire pressure sensors mounted in communication with tires mounted to the wheels of the motor vehicle to provide tire pressure measurements;
an ambient temperature sensor providing temperature measurements;
a vehicle velocity sensor providing vehicle velocity measurements;
a real time source; and
a body computer installed on the vehicle coupled to receive the tire pressure, ambient temperature and vehicle velocity measurements and having access to the real time source, the body computer including cold leak detection programming providing norms in terms of a target tire pressure at a defined temperature and responsive upon execution to the target tire pressure, an initial tire pressure measurement and an initial ambient temperature measurement for adjusting the initial tire pressure based on initial temperature before comparing the tire pressure to targets.

2. A tire pressure management system as claimed in claim 1, further comprising:
the programming further providing for determining the availability of internal tire temperatures, and responsive to a lack of availability, for setting the cold leak detection routine into execution.

3. A tire pressure management system as claimed in claim 2, further comprising:
executable means for revising pressure warning levels responsive to a shift in expected ambient temperatures.

4. A tire pressure management system as claimed in claim 3, further comprising:
determining from the vehicle velocity sensor whether the vehicle is in motion; and
executable means responsive to the vehicle being in motion for averaging continuing pressure readings, generating a temperature estimate from the averages continuing pressure reading and adjusting pressure warning levels based on the estimated temperature.

5. A tire pressure management system for a tractor or tractor/trailer vehicle which provides temperature compensation when direct measurement of internal tire temperature is not available, the system comprising:
valve-mounted tire pressure sensors;
an on-board computer;
data uplink connections for tire pressure data, indicating tire location, from the valve-mounted tire pressure sensors to the on-board computer;
an ambient temperature sensor coupled to report ambient temperature to the on-board computer;
program means for execution by the on-board computer for determining availability of direct temperature readings for tires installed on the vehicle and responsive to absence of such readings for initiating indirect temperature compensation of the pressure data; and
indirect temperature compensation program means for execution by the on-board computer operating in response to indication that direct temperature readings are absent, the indirect compensation means adjusting the reported pressures based on the difference between the ambient temperature and the given temperature and comparing the adjusted pressure and to the last adjusted pressure to determine leaks.

6. A tire pressure management system as claimed in claim 5, further comprising:
vehicle velocity sensors coupled to report vehicle movement to the on-board computer; and
program means responsive to the vehicle velocity sensors for monitoring whether the vehicle is, or has recently been, in movement, and responsive thereto determining if the tires may be treated at being at ambient temperature for purposes of executing the indirect temperature compensation program means.

7. A tire pressure management system as claimed in claim 6, further comprising:
program means responsive to indication that the vehicle is in movement and pressure data for estimating internal temperature of the tires from collective pressure data, original base ambient pressure data and original base pressure data.

8. A tire pressure management system as claimed in claim 7, further comprising:
program means operating on the estimated internal temperature for estimating pressure in individual tires and comparing reported pressure data for each tire to its estimate to locate the occurrence of leaks during vehicle operation.

9. A tire pressure management system as claimed in claim 8, further comprising:
means responsive for changes in anticipated ambient temperature for shifting tire pressure limits or warning thresholds.

10. A method of monitoring tires on a vehicle comprising the steps of:
setting a target pressure level and pressure level limits for the tires at a predetermined temperature;
measuring tire pressure;
reporting tire pressure to an on-board computer;
reporting ambient temperature to the on-board computer;
determining whether direct temperature readings for tires installed on the vehicle are absent;
responsive to the absence of such direct temperature readings and upon indication based on absence of movement of the vehicle that the tires are at ambient temperature, adjusting reported tire pressures for differences in the ambient temperature and the predetermined temperature; and
Indicating violations of the pressure limits by the adjusted tire pressure.

11. The method of monitoring tires as claimed in claim 10, further comprising the steps of:
determining if the vehicle has been in movement before indicating that the tires may be treated as being at ambient temperature.

12. The method of monitoring tires as claimed in claim 11, further comprising the steps of:
estimating internal temperature of the tires based on collective pressure in the tires after the vehicle has been in movement and determining leaks by estimating the change in pressure for a given tire based on the estimated internal temperature and comparing it to measured pressure.
